(19) United States
(12) Patent Application Publication
(10) Pub. No.: US 2026/0264245 A1
(43) Pub. Date: Sep. 10, 2026

(54) METHOD, CONTROL MODULE, AND TELEOPERATION SYSTEM FOR CONTROLLING SYNCHRONIZATION OF TELEOPERATION BASED ON USER-VISUAL MOTION

(71) Applicant: ELECTRONICS AND TELECOMMUNICATIONS RESEARCH INSTITUTE, Daejeon (KR)

(72) Inventor: Tae-Woo KIM, Daejeon (KR)

(21) Appl. No.: 19/382,940

(22) Filed: Nov. 7, 2025

(30) Foreign Application Priority Data
Mar. 4, 2025 (KR) 10-2025-0027684

(51) Int. Cl. B25J 9/16; G06F 3/01

(52) U.S. Cl. CPC B25J 9/1689; G06F 3/013

(57) ABSTRACT

Disclosed herein are a method, control module, and teleoperation system for controlling the synchronization of a teleoperation based on a user-visual motion. The control module may include storage configured to store a preset release threshold and a controller configured to receive a detection signal obtained by detecting a portion related to an eye of a master in a state in which the master and a slave have been synchronized, identify whether an eye closing motion of the master that closes the eye is held for a time indicated by a preset release threshold based on the received detection signal, and release the synchronization when the eye closing motion is held for the time.

### CROSS REFERENCE TO RELATED APPLICATION

This application claims the benefit of Korean Patent Applications No. 10-2025-0027684, filed on March 4, 2025, which is hereby incorporated by reference in its entireties into this application.

### BACKGROUND OF THE INVENTION

### 1. Technical Field

The present disclosure relates generally to a method, control module, and teleoperation system for controlling the synchronization of a teleoperation based on a user-visual motion, and more particularly to a method, control module, and teleoperation system for controlling the synchronization of a teleoperation based on a user-visual motion, which belong to a technical field related to avatar control in a teleoperation system, a robot, and a virtual environment and control a clutch operation based on a visual motion of a user.

### 2. Description of Related Art

In general, a teleoperation system includes a master that is responsible for a source input and a slave that is remotely connected to the master and reenacts a motion of the master in real time. This technology is used to remotely control avatar in a robot or a virtual environment, and is recently widely used in various fields along with the development of the robot, virtual reality (VR) and augmented reality (AR) technologies.

In the existing teleoperation process, a motion of a user interacts with an environment by being synchronized with a motion of a robot or avatar in real time, thereby performing a task. In this process, synchronization and desynchronization processes are necessary between a master and a slave. A task that releases the synchronization requires a special clutch mechanism.

In the existing clutch mechanism, a method of pressing a button by a physical clutch pedal, a voice command, or another hand is basically used. However, such a method becomes a hindrance to an interaction with an environment and the execution of a task in a situation in which a master has been fully synchronized with a slave, such as the whole body motion or voice of a user in the synchronization and desynchronization processes. Furthermore, in a resynchronization process after desynchronization, a user may cause an unwanted discontinuous slave motion.

Accordingly, there is a need for a new method capable of guaranteeing the continuity of a slave motion as much as possible in a resynchronization process while minimizing an influence on an interaction with an environment and the execution of a task in synchronization and desynchronization processes between a master (e.g., a user) and a slave (e.g., a robot or avatar).

U.S. Patent Publication No. US 2022-0179483 relates to technology in which an operation of a surgery robot based on a user’s gaze is naturally released, and discloses technology in which an operation control mode of a surgery robot is released when a user’s gaze falls outside for a preset time or more.

### SUMMARY OF THE INVENTION

An object of the present disclosure is to provide a method, control module, and teleoperation system for controlling the synchronization of a teleoperation based on a user-visual motion, which provide a mechanism that minimizes a physical distraction which may occur in an interaction with an environment and the execution of a task through a teleoperation in a synchronization release process.

Another object of the present disclosure is to provide a method, control module, and teleoperation system for controlling the synchronization of a teleoperation based on a user-visual motion, wherein a user can naturally release a synchronization state and resynchronize an intended motion in the state in which the intended motion at a desynchronization time point has been held as much as possible.

A further object of the present disclosure is to provide a method, control module, and teleoperation system for controlling the synchronization of a teleoperation based on a user-visual motion, which can guarantee the continuity of a natural operation by holding the pose of a robot or avatar upon release of synchronization and support that a user can easily resume synchronization by providing a virtual pose at a resynchronization time point.

A method of controlling the synchronization of a teleoperation based on a user-visual motion according to embodiments of the present disclosure may include receiving a detection signal obtained by detecting a portion related to an eye of a master in the state in which the master and a slave have been synchronized, identifying whether an eye closing motion of the master that closes the eye is held for a time indicated by a preset release threshold based on the received detection signal, and releasing the synchronization when the eye closing motion is held for the time.

The method of controlling the synchronization of a teleoperation based on a user-visual motion may further include receiving a motion detection signal obtained by detecting a motion of the master. The identifying of whether the eye closing motion is held for the time may include identifying whether the eye closing motion is held for the time in the state in which the stop of the motion of the master has been held, based on the received motion detection signal and the detection signal. The releasing of the synchronization may include releasing the synchronization when the eye closing motion is held for the time in the state in which the stop of the motion of the master has been held.

The releasing of the synchronization may include providing an external audio signal to provide notification that a process of releasing the synchronization has been completed.

The method of controlling the synchronization of a teleoperation based on a user-visual motion may further include storing a slave pose of the slave at a time point at which the synchronization is released.

The method of controlling the synchronization of a teleoperation based on a user-visual motion may further include providing the stored slave pose in the state in which the synchronization has been released, receiving a second motion detection signal obtained by detecting a motion of the master in the state in which the synchronization has been released, identifying whether the master holds a pose associated with the slave pose for a second time indicated by a preset resynchronization threshold based on the received second motion detection signal in the state in which the synchronization has been released, and performing resynchronization between the master and the slave when the associated pose is held for the second time.

The method of controlling the synchronization of a teleoperation based on a user-visual motion may further include receiving a second detection signal obtained by detecting a portion related to the eye of the master in the state in which the synchronization has been released. The identifying of whether the master holds the pose associated with the slave pose for the second time may include identifying whether the eye closing motion is held for the second time based on the received second detection signal in the state in which the associated pose has been held. The performing of the resynchronization may include performing the resynchronization when the eye closing motion is held for the second time in the state in which the associated pose has been held for the second time.

The performing of the resynchronization may include providing an external audio signal to provide notification that a process for the resynchronization has been completed.

The eye of the master may include the right eye and left eye of the master.

The release threshold and the resynchronization threshold may be identically or differently set.

An apparatus for controlling the synchronization of a teleoperation based on a user-visual motion according to embodiments of the present disclosure may include a storage configured to store a preset release threshold and a controller configured to receive a detection signal obtained by detecting a portion related to an eye of a master in the state in which the master and a slave have been synchronized, identify whether an eye closing motion of the master that closes the eye is held for a time indicated by a preset release threshold based on the received detection signal, and release the synchronization when the eye closing motion is held for the time.

The controller may receive a motion detection signal obtained by detecting a motion of the master, may identify whether the eye closing motion is held for the time in the state in which the stop of the motion of the master has been held, based on the received motion detection signal and the detection signal, and may release the synchronization when the eye closing motion is held for the time in the state in which the stop of the motion of the master has been held.

The controller may control that an external audio signal to provide notification that a process of releasing the synchronization has been completed is provided.

The controller may store a slave pose of the slave at a time point at which the synchronization is released in the storage.

The storage may further store a preset resynchronization threshold. The controller may control that the stored slave pose is provided in the state in which the synchronization has been released, may receive a second motion detection signal obtained by detecting a motion of the master in the state in which the synchronization has been released, may identify whether the master holds a pose associated with the slave pose for a second time indicated by a preset resynchronization threshold based on the received second motion detection signal in the state in which the synchronization has been released, and may perform resynchronization between the master and the slave when the associated pose is held for the second time.

The controller may receive a second detection signal obtained by detecting a portion related to the eye of the master in the state in which the synchronization has been released, may identify whether the eye closing motion is held for the second time based on the received second detection signal in the state in which the associated pose has been held, and may perform the resynchronization when the eye closing motion is held for the second time in the state in which the associated pose has been held.

The controller may control that an external audio signal to provide notification that a process for the resynchronization has been completed is provided.

The eye of the master may include the right eye and left eye of the master.

The release threshold and the resynchronization threshold may be identically or differently set.

A teleoperation system for controlling the synchronization of a teleoperation based on a user-visual motion according to embodiments of the present disclosure may include a sensor unit configured to output a detection signal obtained by detecting a portion related to an eye of a master and a control module configured to receive the detection signal in the state in which the master and a slave have been synchronized, identify whether an eye closing motion of the master that closes the eye is held for a time indicated by a preset release threshold based on the received detection signal, and release the synchronization when the eye closing motion is held for the time.

The sensor unit may further output a motion detection signal obtained by detecting a motion of the master. The control module may receive the motion detection signal, may identify whether the eye closing motion is held for the time in the state in which the stop of the motion of the master has been held, based on the received motion detection signal and the detection signal, and may release the synchronization when the eye closing motion is held for the time in the state in which the stop of the motion of the master has been held.

According to the method, control module, and teleoperation system for controlling the synchronization of a teleoperation based on a user-visual motion according to embodiments of the present disclosure, a user can naturally perform a clutch command even without using a hand or another physical trigger through an eye motion.

Synchronization release and resynchronization processes can be smoothly performed compared to the existing clutch method and user experiences of a teleoperation can be greatly improved because an eye motion of a user is tracked by using a VR device or a visual sensor and a clutch release and resynchronization function is implemented in a synchronized state based on the tracking.

A user does not experience confusion when resuming a stopped task because a motion of a robot or avatar is held upon release of synchronization. A synchronization process can be simplified because a virtual pose is automatically provided at a clutch resynchronization time point. Accordingly, efficiency of a teleoperation system can be improved, and a user’s fatigue can be reduced.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating a configuration of a teleoperation system according to an embodiment of the present disclosure.

FIG. 2 is a view illustrating a configuration of the teleoperation system in a picture form according to an embodiment of the present disclosure.

FIG. 3 is a view for describing a clutch-based desynchronization process between a master and a slave according to an embodiment of the present disclosure.

FIG. 4 is a view illustrating a motion of the eyes of a slave synchronized with a master.

FIG. 5 is a view for describing a clutch-based resynchronization process between a master and a slave according to an embodiment of the present disclosure.

FIG. 6 is a view illustrating a master that assumes a pose in accordance with the final pose of a slave that is guided by VR hologram.

FIG. 7 is a flowchart illustrating a synchronization release process in a method of controlling the synchronization of a teleoperation based on a user-visual motion according to an embodiment of the present disclosure.

FIG. 8 is a flowchart illustrating a resynchronization process in the method of controlling the synchronization of a teleoperation based on a user-visual motion according to an embodiment of the present disclosure.

FIG. 9 is a block diagram illustrating a configuration of a teleoperation processor according to an embodiment of the present disclosure.

FIG. 10 is a flowchart illustrating a process of the teleoperation processor releasing synchronization with a slave by using a visual clutch according to an embodiment of the present disclosure. The method of controlling the synchronization of a teleoperation based on a user-visual motion according to embodiments of the present disclosure may include a process of FIG. 11.

FIG. 11 is a flowchart illustrating a process of the teleoperation processor resuming the synchronization of a master and a slave by taking over the final pose according to an embodiment of the present disclosure. The method of controlling the synchronization of a teleoperation based on a user-visual motion according to embodiments of the present disclosure may include the process of FIG. 11.

FIG. 12 is a block diagram illustrating a configuration of a teleoperation system according to another embodiment of the present disclosure.

FIG. 13 is a view illustrating a configuration of a computer system according to an embodiment of the present disclosure.

### DESCRIPTION OF THE PREFERRED EMBODIMENTS

The present disclosure may be modified in various ways and may have various embodiments. Specific embodiments are to be illustrated in the drawings and to be described in the detailed description. It is however to be understood that the present disclosure is not intended to be limited to the specific embodiments, but that the specific embodiments include all of modifications, equivalents and/or substitutions included in the spirit and technical scope of the present disclosure.

For the following detailed description of the present disclosure, reference is made to the accompanying drawings as examples of specific embodiments. The embodiments are described in detail in order for those skilled in the art to readily implement the embodiments. It is to be understood that various embodiments are different from each other, but do not need to be exclusive. For example, a specific shape, structure, and characteristic described in this specification may be implemented as another embodiment without departing from the spirit and scope of the present disclosure in relation to an embodiment. It is also to be understood that the position or arrangement of each component within each disclosed embodiment may be changed without departing from the spirit and scope of the present disclosure. Accordingly, the following detailed description is not intended to have a limited meaning. The range of the embodiment is restricted by only the claims along with all ranges equivalent to that written in the claims if it is appropriately described.

In the drawings, similar reference numerals denote the same or similar functions in several aspects. The shapes, sizes, etc. of components in the drawings may be exaggerated for a clearer description. Furthermore, the term “and/or” may include a combination of a plurality of related and described items or any one of a plurality of related and described items. In embodiments of the present disclosure, the terms “part”. “unit”, and “module” used may include one or more components, and may include a software component and/or a hardware component.

In embodiments of the present disclosure, terms, such as a first and a second, may be used to describe various components, but the components should not be restricted by the terms. The terms are used to only distinguish one component from the other components. For example, a first component may be named a second component without departing from the scope of rights of the present disclosure. Likewise, a second component may be named as a first component.

When it is described that one component is “connected” or “coupled” to the other component, it should be understood that the two components may be directly connected or coupled, but another component may be present between the two components. In contrast, when it is described that one component is “directly connected” or “directly coupled” to the other component, it should be understood that another component is not present between the two components.

Components described in the embodiments are independently illustrated in order to indicate different and characteristic functions. It does not mean that each of the components is formed of separated hardware or a piece of a software unit. That is, the components are arranged and included, for convenience of a description, and at least two of the components may be combined to form one component or one component may be divided into a plurality of components that perform functions. An embodiment in which some components are integrated or embodiments in which some components are separated are also included in the scope of rights of the present disclosure unless they depart from the essence of the present disclosure.

The terms used in the embodiments are used to only describe specific embodiments and are not intended to restrict the present disclosure. An expression of the singular number should be construed as including an expression of the plural number unless clearly defined otherwise in the context. It is to be understood that in the embodiments, a term, such as “include (or comprise)” or “have”, is intended to designate the presence of a characteristic, a number, a step, an operation, a component, a part or a combination of them described in the specification and does not exclude the possible existence or addition of one or more other characteristics, numbers, steps, operations, components, parts or combinations of them in advance. That is, in the embodiments, contents describing that a specific component is “included” do not exclude a component other than a corresponding component, and mean that an additional component may also be included in an implementation of the present disclosure or the scope of the technical spirit of the present disclosure.

In the embodiments, the term “at least one” may mean one of one or more numbers, such as 1, 2, 3, and 4. In the embodiments, “a plurality of” may mean one of two or more numbers, such as 2, 3, and 4.

At least some of parts, units, and modules described in the embodiments may be program modules, and may communicate with an external device or system.

The program modules may perform a function or operation according to an embodiment or may embrace a routine, a subroutine, a program, an object, a program component, and a data structure that implement an abstract data type according to an embodiment, but is not limited thereto.

Some components disclosed in the present disclosure may not be essential components that perform essential functions, but may be optional components for improving only performance. The embodiments may be implemented with only components essential to implement the essence of the present disclosure other than components used to improve only performance, and a structure including only essential components other than optional components used to improve only performance is also included in the scope of rights of the present disclosure.

Hereinafter, embodiments are described in detail with reference to the accompanying drawings in order for a person having ordinary knowledge in the art to easily implement the embodiments. In describing the embodiments, a detailed description of a related known component or function will be omitted if it is deemed to make the subject matter of the present disclosure vague. Furthermore, in the drawings, the same reference numeral is used in the same component, and a redundant description of the same component is omitted.

A teleoperation system according to embodiments of the present disclosure may perform natural synchronization and desynchronization in a process of teleoperating a target agent based on a visual sensor that tracks a motion of a user by using a clutch technique based on a user-visual motion. Specifically, a teleoperation system according to embodiments of the present disclosure may track an eye motion of a user by using a VR device or a visual sensor and perform a clutch release and resynchronization function in a synchronized state based on the tracking.

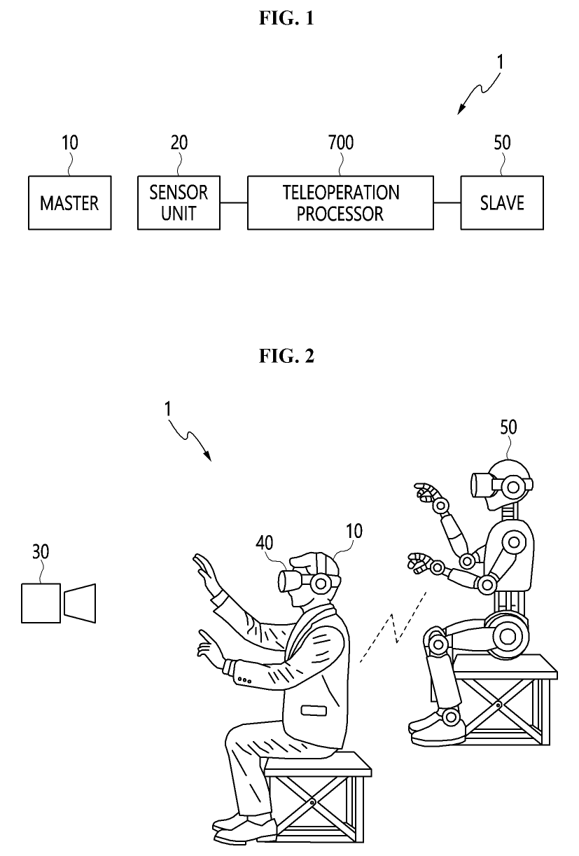

FIG. 1 is a block diagram illustrating a configuration of a teleoperation system according to an embodiment of the present disclosure. FIG. 2 is a view illustrating a configuration of the teleoperation system in a picture form according to an embodiment of the present disclosure.

Referring to FIGS. 1 and 2, the teleoperation system 1 according to embodiments of the present disclosure may include a master 10, a sensor unit 20, a slave 50, and a teleoperation processor 700.

The master 10 is responsible for the generation of a source input motion, and basically denotes a human. That is, the master 10 may be a user (i.e., a human) who is responsible for the generation of a source input motion.

The sensor unit 20 may elaborately track a gesture movement and eye motion of a user, and may include at least one VR device and visual sensor.

The slave 50 receives a motion of the master 10 and imitates the motion of the master 10 in real time. The slave 50 may receive a motion of the master 10 in real time from the teleoperation processor 30 and imitate the received motion in real time. The slave 50 may be a robot or avatar in a virtual environment.

The teleoperation processor 700 may control synchronization and desynchronization between the master 10 and the slave 50, may detect a motion of the master 10, and may transmit the detected motion of the master 10 to the slave 50.

The teleoperation processor 700 may perform a visual clutch mechanism that performs synchronization and desynchronization between the master 10 and the slave 50 based on an eye motion of a user.

An operation that is performed in a synchronization release process performed by the teleoperation system 1 is as follows.

Motion stop and eye closing motions: the master 10 stops its motion while performing a teleoperation and maintains the state in which the master has closed its two eyes.

A threshold detection operation: the teleoperation system 1 measures a designated threshold (e.g., an eye closing state and a motion stop state continue for a predetermined time) based on an environment and setting.

A synchronization release operation: when the threshold is satisfied, the teleoperation system 1 releases synchronization with the slave along with an external audio signal.

A slave pose storage operation: the teleoperation system 1 stores a slave pose at a synchronization release time point and uses the stored slave pose upon future resynchronization.

An operation that is performed in a resynchronization release process performed by the teleoperation system 1 is as follows.

A VR hologram provision operation: the teleoperation system 1 provides the master 10 with the final pose of the slave 50 in the form of VR hologram.

A pose matching motion: the master 10 matches its own pose in accordance with the provided hologram.

Eye opening and holding motion: the master 10 maintains the state in which the two eyes are open for a predetermined time without blinking the two eyes in the pose matching motion state.

A threshold detection operation: the teleoperation system 1 identifies whether the pose and the eye opening state are maintained for a set threshold.

A resynchronization completion operation: when the threshold is satisfied, the teleoperation system 1 identifies that a synchronization process has been completed along with an external audio signal.

A teleoperation resumption operation: the master 10 is naturally synchronized with the slave 50 from the pose at the final synchronization release time point and continually performs the teleoperation.

The teleoperation system 1 according to embodiments of the present disclosure may perform a visual clutch function that enables natural synchronized/desynchronization to be performed in a process of teleoperating the target slave 50 based on the sensor unit 20 that tracks a motion of the master 10.

FIG. 2 is a view illustrating a configuration of the teleoperation system in a picture form according to an embodiment of the present disclosure.

Referring to FIG. 2, the sensor unit 20 may include a camera sensor 30 and virtual reality (VR) goggles 40. The camera sensor 30 may elaborately track a gesture movement of a user. The camera sensor 30 may be installed in a range in which a pose of the master 10 may be detected. That is, the master 10 may be disposed within the range of a view angle of the camera sensor 30.

The VR goggles 40 may elaborately track an eye motion of a user. In this case, the VR goggles 40 may be worn on the face of the master 10 so that the eyes of the master 10 and surroundings thereof are covered.

The slave 50 may be disposed at the same place as the master 10, and may be disposed at a place different from the place of the master 10. The slave 50 may transmit and receive data to and from the teleoperation processor 700 in a wireless and/or wired manner.

In particular, a master-slave teleoperation has been mainly defined through a synchronized connection between machine devices having the same or similar mechanical units in the robot research field. In the case of a mutual dedicated connection device, coupling and decoupling processes rarely occur. However, in a construction in which a human is a master, a frequent coupling/decoupling process occurs because a permanent connection is difficult. There is a case in which natural connectivity is lost in the frequent coupling/decoupling process. The teleoperation system 1 according to embodiments of the present disclosure may perform a visual clutch method capable of performing coupling with and decoupling from the slave 50 based on an eye motion of the master 10 in order to naturally perform the coupling/decoupling process as much as possible.

The visual clutch method is a method of triggering synchronization/desynchronization with a slave based on a motion of an eye of a user, in particular, the eyelid of the user.

FIG. 3 is a view for describing a clutch-based desynchronization process between the master and the slave according to an embodiment of the present disclosure. FIG. 3 illustrates a process of performing desynchronization with the slave by detecting an eye motion of a user in a situation in which the master and the slave perform a teleoperation in the state in which the master and the slave have already been synchronized.

Referring to FIG. 3, in the state 301 in which the master 10 and the slave 50 have been synchronized, the master 10 stops its motion while performing a teleoperation and maintains the state 11 in which the master has closed its two eyes. The teleoperation processor 700 measures a stop time based on a set threshold depending on an environment and the situation of the teleoperation system 1, and may release synchronization with the slave 50 along with an external audio signal 302 when the state in which the two eyes have stayed been closed and the motion stop state are maintained for the stop time. The external audio signal 302 may notify the user that the synchronization release process has been completed. When the teleoperation processor 700 releases the synchronization, the master 10 and the slave 50 may be in the state 303 in which the master and the slave have been desynchronized. In this case, the external audio signal 302 may be output by the teleoperation processor 700, and may be output by the VR goggles 40 under the control of the teleoperation processor 700.

The teleoperation processor 700 separates stores a slave pose 51 at the synchronization release time point simultaneously with the release of the synchronization. The slave pose 51 may be used when the master 10 resumes synchronization with the slave while maintaining motion information at the release time point as much as possible, when performing the synchronization with the slave 50 again in the future.

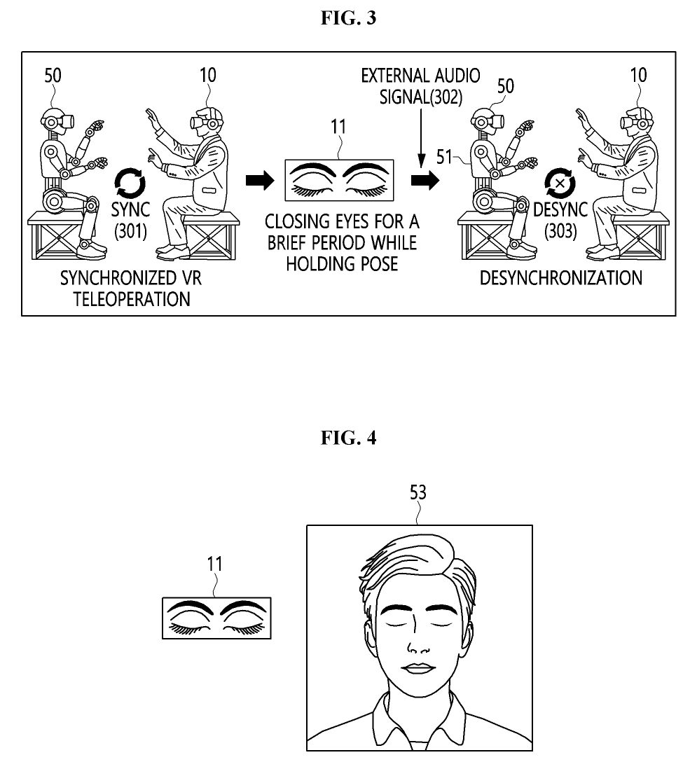

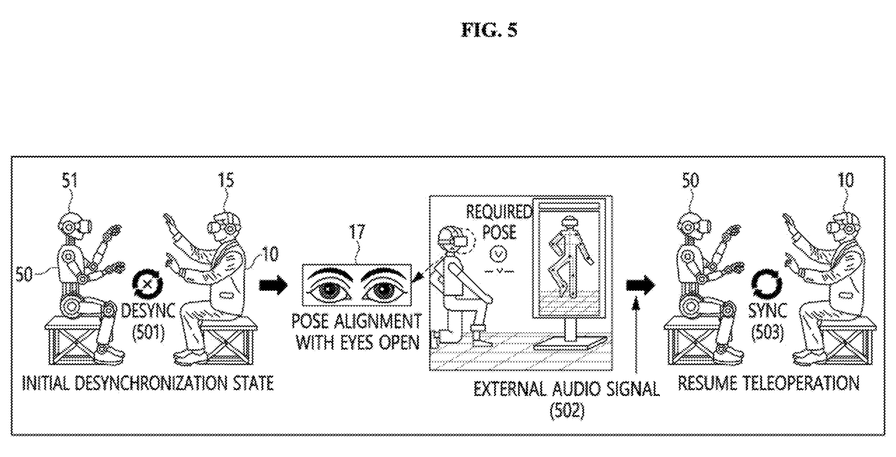

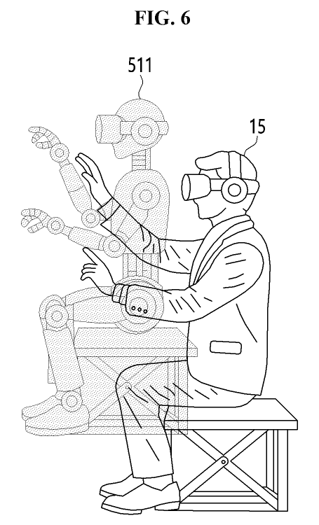

FIG. 4 is a view illustrating a motion of the eyes of a slave synchronized with a master.

Referring to FIG. 4, for example, when the master 10 is synchronized with the avatar 50, performs a motion, and then releases the synchronization with the avatar 50 in order to leave for a while in an online-connected virtual environment, if the eyes of the avatar 50 also maintain the state 53 in which the eyes of the avatar have been closed as illustrated in FIG. 4 in accordance with the state 11 in which the master 10 have closed the two eyes, other users may be aware that the avatar 50 is in the state in which the avatar has been desynchronized with the master 10. Accordingly, the teleoperation system 1 according to embodiments of the present disclosure can make a counterpart’s state information clearly known in an interaction with another user, and can increase an interaction effect. Furthermore, it is expected that the teleoperation system 1 according to embodiments of the present disclosure can provide the same social effect in operating an actual robot in addition to avatar in a virtual environment.

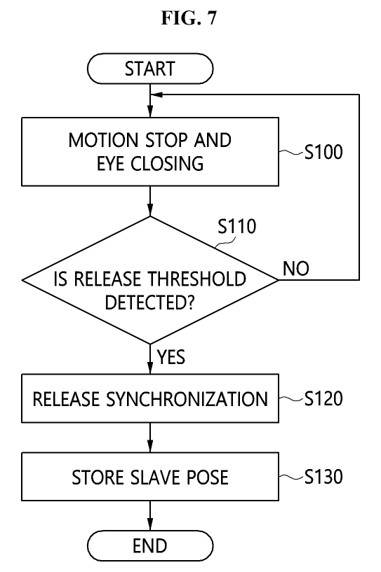

FIG. 5 is a view for describing a clutch-based resynchronization process between a master and a slave according to an embodiment of the present disclosure.

Referring to FIG. 5, when the master 10 attempts synchronization with the slave 50 again in a situation 501 in which synchronization has been released, a process for a continuous teleoperation may be added.

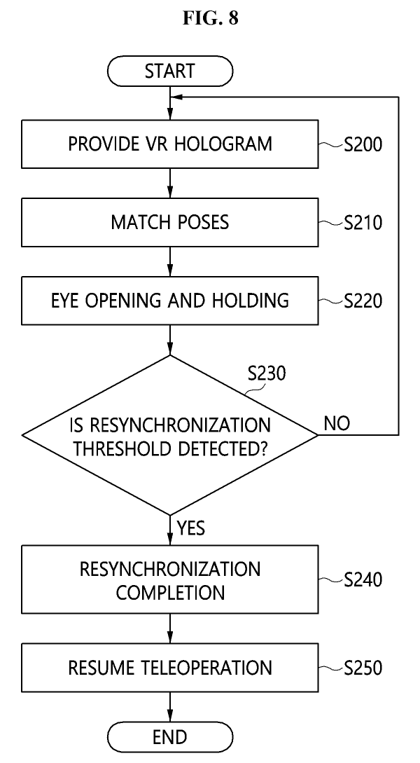

FIG. 6 is a view illustrating the master that assumes a pose in accordance with the final pose of the slave that is guided by VR hologram.

Referring to FIG. 6, after wearing the VR goggles 40, the master 10 needs to match its own pose 15 with the final pose of the slave 50, which is provided in the form of VR hologram 511 through the VR goggles 40. The master 10 maintains the state 17 in which the two eyes of the master 10 have stayed open without blinking for a predetermined time in the state in which the pose 15 has been matched with the VR hologram 511. When the master 10 maintains the pose 15 and the state 17 in which the two eyes have stayed open for a preset threshold, the teleoperation processor 700 may notify the user that a synchronization process has been completed along with an external audio signal 502. When the teleoperation processor 700 resumes synchronization, the master 10 and the slave 50 may be in the state 503 in which the master and slave have been synchronized. The master 10 is naturally synchronized with the slave 50 based on the pose at the final synchronization release time point, and may continually perform the teleoperation. The external audio signal 502 may be output by the teleoperation processor 700. The VR goggles 40 may be output under the control of the teleoperation processor 700.

After detecting that the final pose 511 of the slave 50 is in a situation in which a motion of the master 10 is stationary, the teleoperation processor 700 may read information on the slave pose 51, which has been stored in the synchronization release process, and may visualize the read information on the slave pose 51 for the master 10.

As described above, the teleoperation system 1 according to embodiments of the present disclosure can minimize a hindrance to a physical interaction and is also effective in terms of social aspects, such as a state display, interaction improvements, and the application or a robot operation. The teleoperation system 1 according to embodiments of the present disclosure has an effect in that another user can be notified of a desynchronization state by maintaining the state in which the eyes of the avatar 50 have also been closed when the master 10 is moved by being synchronized with the avatar 50 and then releases the synchronization in an online virtual environment in terms of the social display, can increase an interaction effect by enabling other users to clearly check a counterpart’s state information in terms of the interaction improvements, and can have a social effect although an actual robot is operated in addition to avatar in a virtual environment in terms of the application of the robot operation.

FIG. 7 is a flowchart illustrating a synchronization release process in a method of controlling the synchronization of a teleoperation based on a user-visual motion according to an embodiment of the present disclosure.

Referring to FIG. 7, the sensor unit 20 detects motion stop and eye closing motions of the master 10 (S100). In the state 301 in which the master 10 and the slave 50 have been synchronized, when the master 10 stop a motion while performing a teleoperation and maintains the state 11 in which the two eyes of the master have been closed, the sensor unit 20 may detect the motion stop and eye closing motions of the master 10. In step S100, the sensor unit 20 may transmit a release detection signal indicative of the sensed motion stop and eye closing motions to the teleoperation processor 700. The teleoperation processor 700 may receive the release detection signal transmitted by the sensor unit 20.

In step S100, the camera sensor 30 may detect the user motion of the master 10 and transmit a motion detection signal indicative of the sensed user motion to the teleoperation processor 700. In this case, the motion detection signal may be a video signal.

In step S100, the VR goggles 40 may detect the eye closing motion of the master 10 and transmit an eye closing detection signal indicative of the detected eye closing motion of the master 10 to the teleoperation processor 700.

The release detection signal transmitted by the sensor unit 20 may include at least one of a motion detection signal and an eye closing detection signal.

The teleoperation processor 700 performs a release threshold detection operation (S110). When receiving the release detection signal from the sensor unit 20, the teleoperation processor 700 may perform step S110. In step S110, the teleoperation processor 700 may measure the stop time of the motion stop and eye closing motions by using the release detection signal, and may identify whether the motion stop and eye closing motions have been held for a preset release threshold. In some embodiments, in step S110, the teleoperation processor 700 may perform the release threshold detection operation on only the eye closing motion. In this case the release threshold may be a time value.

When the motion stop and eye closing motions are held for the preset release threshold as a result of the identification, the teleoperation processor 700 performs a synchronization release operation (S120). In step S120, the teleoperation processor 700 may release the synchronization with the slave 50. Furthermore, in step S120, the teleoperation processor 700 may output the external audio signal 302 that notifies the user that the synchronization release process has been completed. When step S120 is performed, the master 10 and the slave 50 may be in the state 303 in which the master and the slave have been desynchronized.

The teleoperation processor 700 performs a slave pose storage operation (S130). In step S130, the teleoperation processor 700 may separately store the slave pose 51 at the synchronization release time point simultaneously with the release of the synchronization. The stored slave pose 51 may be used when the master 10 performs synchronization with the slave 50 again in the future. In this case, after detecting that the final pose 511 of the slave 50 is in the situation in which the motion of the master 10 is stationary, the teleoperation processor 700 may store the final pose 511 of the slave 50 as information on the slave pose 51.

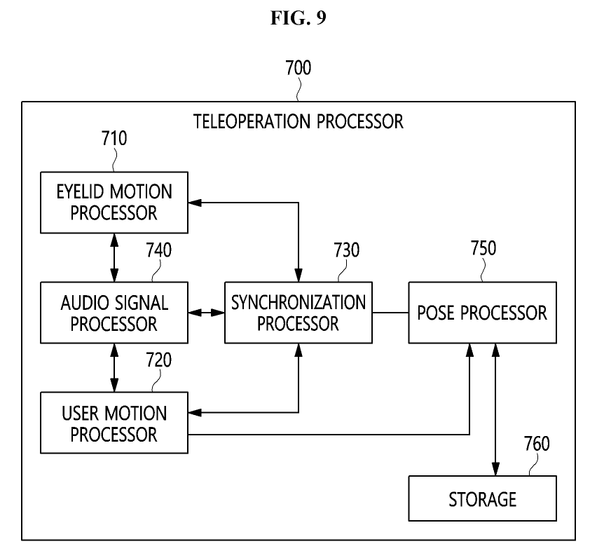

FIG. 8 is a flowchart illustrating a resynchronization process in the method of controlling the synchronization of a teleoperation based on a user-visual motion according to an embodiment of the present disclosure.

Referring to FIG. 8, when the master attempts synchronization with the slave 50 again in the situation 501 in which the synchronization has been released according to the method of FIG. 7, the method of FIG. 8 may be performed.

The VR goggles 400 perform a VR hologram provision operation (S200). When the master 10 wears the VR goggles 40, in step S200, the teleoperation processor 700 may control the VR goggles 40 to display the VR hologram 511. In this case, the VR hologram 511 may be the information on the slave pose 51, which was stored in the synchronization release process after the teleoperation processor 700 detects that the final pose 511 of the slave 50 is in the situation in which the motion of the master 10 is stationary.

In step 210, the master 10 performs a pose matching motion. The master 10 needs to match the pose 15 with the pose of the VR hologram 511 that is provided through the VR goggles 40. In step S210, the camera sensor 30 may photograph a pose of the master 10 and transmit a pose image, including the photographed pose of the master 10, to the teleoperation processor 700.

In step S220, the master 10 performs eye opening and holding motions. The master 10 needs to maintain the state 17 in which the two eyes have stayed open without blinking for a predetermined time in the state in which the own pose 15 has been matched with the pose of the VR hologram 511. In step S220, the VR goggles 40 may detect the eye opening and holding motions of the master 10 and transmit an eye holding detection signal indicative of the detected eye opening and holding motions of the master 10 to the teleoperation processor 700.

The teleoperation processor 700 performs a resynchronization threshold detection operation (S230). When receiving the pose image from the camera sensor 30 and receiving the eye holding detection signal from the VR goggles 40, the teleoperation processor 700 may perform step S230. In step S230, the teleoperation processor 700 may identify whether the eye opening and holding motions of the master 10 have been held in the state in which the pose of the master 10 has been matched with the pose of the VR hologram 511 for the preset resynchronization threshold. In some embodiments, in S230, the teleoperation processor 700 may perform the resynchronization threshold detection operation on only one of the eye opening and holding motions. In this case, the resynchronization threshold may be a time value.

When the master 10 holds the eye opening and holding motions in the state in which the pose of the master 10 has been matched with the pose of the VR hologram 511 for the preset resynchronization threshold as a result of the identification, the teleoperation processor 700 performs a resynchronization completion operation (S240). In step S240, the teleoperation processor 700 may output the external audio signal 502 that notifies the user that the synchronization process has been completed.

The teleoperation processor 700 performs a teleoperation resumption operation (S250). In step S250, the master 10 and the slave 50 may be in the state 503 in which the master and the slave have been synchronized. The master 10 is naturally synchronized with the slave 50 based on the pose at the final synchronization release time point, and may continually perform the teleoperation.

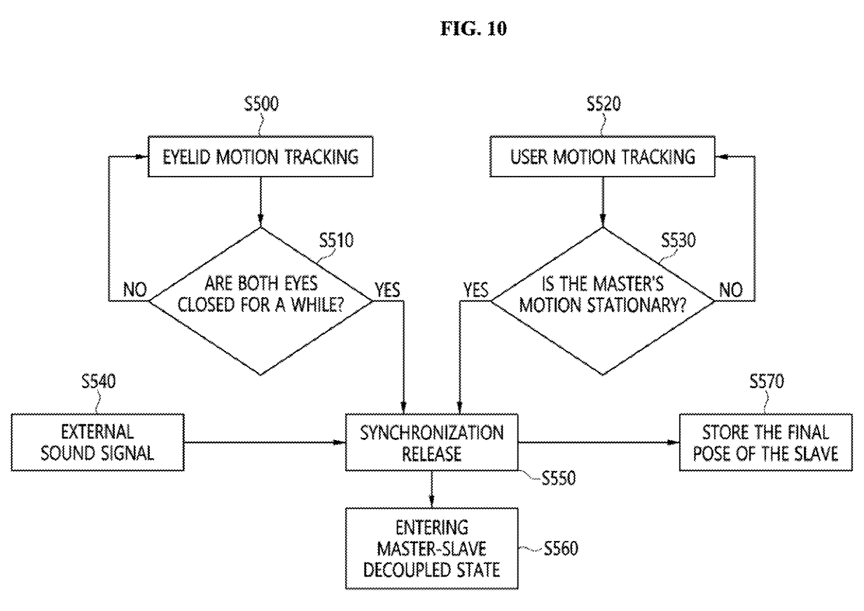

FIG. 9 is a block diagram illustrating a configuration of the teleoperation processor according to an embodiment of the present disclosure.

Referring to FIG. 9, the teleoperation processor 700 may include an eyelid motion processor 710, a user motion processor 720, a synchronization processor 730, an audio signal processor 740, a pose processor 750, and a storage 760.

The storage 760 may store the external audio signals 302 and 502, the release threshold, and the resynchronization threshold. The release threshold and the resynchronization threshold may be previously reset and stored in the storage 760, and may be reset by an administrator or a user.

The audio signal processor 740 may access the external audio signals 302 and 502 stored in the storage 760, and may provide the accessed external audio signals 302 and 502.

FIG. 10 is a flowchart illustrating a process of the teleoperation processor releasing synchronization with the slave by using a visual clutch according to an embodiment of the present disclosure.

Referring to FIG. 10, in the state 301 in which the master 10 and the slave 50 have been synchronized, the VR goggles 40 tracks an eyelid motion of the master 10 (S500). The eyelid motion processor 710 may receive a detection signal indicative of the eyelid motion tracked by the VR goggles 40 in step S500 from the VR goggles 40. In this case, the detection signal may include an eye closing detection signal. In some embodiments, the eye closing detection signal may be a detection signal indicative of a motion of the master 10 in the state in which the eyelids of both eyes of the master have covered both the eyes of the master. In some embodiments, the eye closing detection signal may be a detection signal indicative of a motion of the master 10 in the state in which the eyelid of the eye of the master on one side thereof has covered the eye of the master on one side thereof.

The eyelid motion processor 710 identifies whether the eyes of the master 10 have been closed for a while (S510). In step S510, the eyelid motion processor 710 may identify whether the eyes of the master 10 have been closed for a release threshold based on the detection signal received in step S500. When the eye closing detection signal is received or maintained for the release threshold, the eyelid motion processor 710 may identify that the eyes of the master 10 have been closed for a while. In some embodiments, in step S500, the eyelid motion processor 710 may identify whether both ends of the master 10 have been closed for the release threshold. In some embodiments, in step S500, the eyelid motion processor 710 may identify whether one of the eyes of the master 10 has been closed for the release threshold.

The camera sensor 30 tracks a user motion of the master 10 (S520) in the state 301 in which the master 10 and the slave 50 have been synchronized. In step S520, the user motion processor 720 may receive a motion detection signal indicative of the user motion tracked by the camera sensor 30 from the camera sensor 30. In this case, the motion detection signal may be a video signal. In step S520, the synchronization processor 730 may control the slave 50 to perform the user motion indicated by the motion detection signal.

The user motion processor 720 identifies whether the motion of the master 10 is stationary (S530). In step S530, the user motion processor 720 may identify whether the stop of the motion of the master 10 has been maintained for the release threshold based on the motion detection signal received in step S520. In step S530, when a currently received motion detection signal corresponds to a previously received motion detection signal for the release threshold, the user motion processor 720 may identify that the motion of the master 10 is in the state in which the motion of the master 10 is stationary for the release threshold.

When the eye closing state and the motion stop state are maintained for the release threshold, the audio signal processor 740 outputs an external audio signal to provide notification that the synchronization release process has been completed (S540), the synchronization processor 730 and releases the synchronization with the slave 50 (S550). In step S550, the synchronization processor 730 may control the slave 50 to be in the state 53 in which the eyes of the slave 50 have been closed.

When the teleoperation processor 700 releases the synchronization, the master 10 and the slave 50 are in the state 303 in which the master and the slave have been desynchronized (or decoupled) (S560).

The pose processor 750 stores the final pose 51 of the slave at the synchronization release time point in the storage 760 (S570).

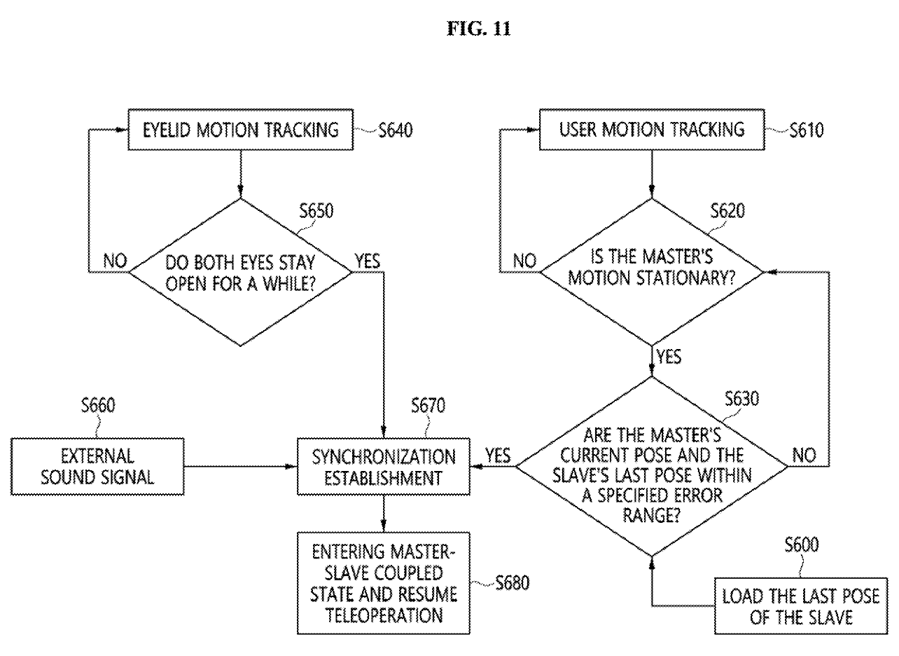

A method of controlling the synchronization of a teleoperation based on a user-visual motion according to embodiments of the present disclosure may include steps S500 to S560 illustrated in FIG. 11.

FIG. 11 is a flowchart illustrating a process of the teleoperation processor resuming the synchronization of a master and a slave by taking over the final pose according to an embodiment of the present disclosure.

Referring to FIG. 11, when the master 10 attempts synchronization with the slave 50 again in the situation 501 in which synchronization has been released according to the method of FIG. 10, the method of FIG. 11 may be performed.

The pose processor 750 loads the slave pose 51 stored in the storage 760 (S600). When the master 10 wears the VR goggles 40, in step S600, the pose processor 750 may control the VR goggles 400 to display the loaded slave pose 51. In this case, the slave pose 51 may have been stored in the storage 760 in step S570.

In the state 501 in which the master 10 and the slave 50 have been desynchronized, the camera sensor 30 tracks a user motion of the master 10 (S610). The user motion processor 720 may receive a motion detection signal indicative of the user motion tracked by the camera sensor 30 in step S610 from the camera sensor 30. In this case, the motion detection signal may be a video signal. In step S610, the master 10 may perform a resynchronization process only when a pose matching motion is performed. The master 10 needs to match its own pose 15 with the pose of the VR hologram 511 that is provided through the VR goggles 40 in step S600.

The user motion processor 720 identifies whether the motion of the master 10 is stationary (S620).

When the motion of the master 10 is stationary, the user motion processor 720 identifies whether the pose of the master 10 is in the state in which the pose of the master has been matched with the pose of the VR hologram 511 for a preset resynchronization threshold (S630). The user motion processor 720 may identify whether the pose of the master 10 is in the state in which the pose of the master has been matched with the pose of the VR hologram 511 for the resynchronization threshold by comparing each of the motion detection signals received in step S620 for the resynchronization threshold with the loaded slave pose 51. When a difference between the pose of the master 10 and the slave pose 51 included in the motion detection signal received in step S620 is within a set error range, the user motion processor 720 may identify that the pose of the master 10 is matched with the pose of the VR hologram 511.

In the state 501 in which the master 10 and the slave 50 have been desynchronized, the VR goggles 40 tracks an eyelid motion of the master 10 (S640). The eyelid motion processor 710 may receive a detection signal indicative of the eyelid motion tracked by the VR goggles 40 in step S640 from the VR goggles 40. In this case, the detection signal may include an eye holding detection signal. In some embodiments, the eye holding detection signal may be a detection signal indicative of a motion in the state in which both eyes have stayed open. In some embodiments, the eye holding detection signal may be a detection signal indicative of a motion in the state in which only one eye has stayed open.

The eyelid motion processor 710 identifies whether the eyes of the master 10 stay open for a while (S650). In step S650, the eyelid motion processor 710 may identify whether the eyes of the master 10 stay open for the resynchronization threshold based on the detection signal received in step S640. When the eye holding detection signal is received or maintained for the resynchronization threshold, the eyelid motion processor 710 may identify that the eyes of the master 10 stay open for a while. In some embodiments, in step S650, the eyelid motion processor 710 may identify whether both eyes of the master 10 are in the state in which both eyes of the master 10 have stayed open for the resynchronization threshold. In some embodiments, in step S650, the eyelid motion processor 710 may identify whether only one eye of the master 10 is in the state in which only one eye of the master 10 has stayed open for the resynchronization threshold.

When the eye opening and holding motion and the pose matching motion are maintained for the resynchronization threshold, the audio signal processor 740 outputs an external audio signal to provide notification that the synchronization process has been completed (S660). The synchronization processor 730 establishes synchronization between the master 10 and the slave 50 (S670).

The synchronization processor 730 performs a teleoperation resumption operation (S680). In step S680, the master 10 and the slave 50 may be in the state 503 in which the master 10 and the slave 50 have been synchronized. The master 10 is naturally synchronized with the slave 50 based on the pose at the final synchronization release time point, and may continually perform the teleoperation.

The method of controlling the synchronization of a teleoperation based on a user-visual motion according to embodiments of the present disclosure may include steps S600 to S680 illustrated in FIG. 11.

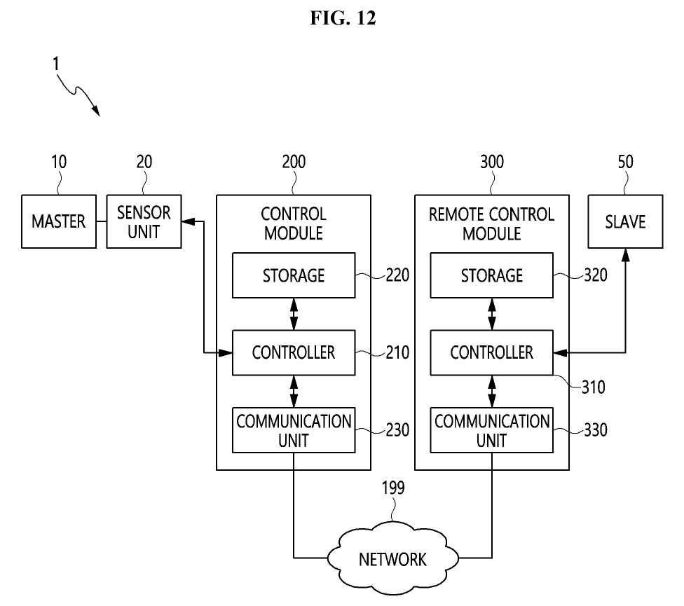

FIG. 12 is a block diagram illustrating a configuration of a teleoperation system according to another embodiment of the present disclosure.

Referring to FIG. 12, the teleoperation system according to embodiments of the present disclosure may include a master 10, a sensor unit 20, a control module 200, a remote control module 300, and the slave 50. The master 10, the sensor unit 20, and the slave 50 are components corresponding to the master 10, the sensor unit 20, and the slave 50 illustrated in FIG. 1, respectively, and detailed descriptions thereof are omitted hereinafter.

The control module 200 may include a controller 210, a storage 220, and a communication unit 230. Program modules may be included in the control module 200 in the form of an operating system, an application program module, and other program modules.

The program modules may be stored in physically various known storage devices. Furthermore, at least some of such program modules may be stored in a remote storage device capable of communicating with the communication unit 230.

The storage 220 may perform the function of the storage 760 illustrated in FIG. 9. That is, the storage 220 may store the slave pose 51. The storage 220 may denote memory and/or storage. The storage 220 may be various types of volatile or nonvolatile storage media. For example, the memory may include at least one of ROM and RAM.

The controller 210 may perform the function of the teleoperation processor 700. Furthermore, the controller 200 may generate a synchronization release message to request synchronization release between the master 10 and the slave 50 and a resynchronization establishment message to request synchronization between the master 10 and the slave 50.

The controller 210 may be a semiconductor device that executes processing instructions stored in the storage 220. The controller 210 may be at least one hardware processor. The controller 210 may include one or more cores, and may include a processor for data analysis and deep learning, such as a central processor (CPU), graphics processor (GPU), digital signal processor (DSP), application specific integrated circuit (ASIC), general purpose graphics processor (GPGPU), and tensor processor (TPU) of the control module 200. The controller 860 may read a computer program stored in the storage 870 and perform data processing for the training of a deep learning network according to an embodiment of the present disclosure.

The program modules may consist of an instruction or a code that is performed by at least one processor of the controller 210.

The controller 210 may execute instructions or codes of the parts, units, and modules described in the embodiments.

The communication unit 230 may transmit and receive data to and from the remote control module 300 or the slave 50 over a network 199. The communication unit 230 may transmit a synchronization release message, a resynchronization establishment message, and information indicative of a motion of the master 10 to the remote control module 300 or the slave 50. The synchronization release message may be generated and transmitted in step S120 of FIG. 7 or step S550 of FIG. 10. The resynchronization establishment message may be generated and transmitted in step S240 of FIG. 8 and step S670 of FIG. 11. The teleoperation processor 700 may generate the synchronization release message, the resynchronization establishment message, and the information indicative of a motion of the master 10, and may transmit the synchronization release message, the resynchronization establishment message, and the information to the remote control module 300 or the slave 50. In this case, the network 199 may be a private network or an Internet network, and may include a wired network or a wireless network. The network 199 may denote an ad hoc network, Intranet, Extranet, Bluetooth, ZigBee, a virtual private network (VPN), a local area network (LAN), a wireless LAN (e.g., IEEE 802.11b, IEEE 802.11a, IEEE802.11g, or IEEE802.11n), wireless broadband (WIBro), a wide area network (WAN), a wireless WAN (WWAN), a metropolitan area network (MAN), Internet, a part of the Internet, a part of a public switched telephone network (PSTN), a plain old telephone service (POTS) network, a cellular phone network, a wireless network, a Wi-Fi® network, other types of networks, or one or more portions of a network which may be a combination of two or more of such networks, and may denote one or more portions of a network to which other types of networks are connected. For example, the network or a part of the network may include a wireless or cellular network. The connection may be a code division multiple access (CDMA) connection, a global system for mobile communications (GSM) connection, or other types of cellular or wireless connections. In such an example, the connection may be implemented with an arbitrary connection, among single carrier radio transmission technology (1xRTT), evolution-data optimized (EVDO) technology, general packet radio service (GPRS) technology, enhanced data rates for GSM evolution (EDGE) technology, third generation partnership project (3GPP) including 3G, fourth generation (4G) wireless) networks, the universal mobile telecommunications system (UMTS), high speed packet access (HSPA), worldwide interoperability for microwave access (WiMAX), the long term evolution (LTE) standard, other things defined by various standard-configuration organizations, other long-distance protocols, or various types of data transmission technologies such as another data transmission technology.

The remote control module 300 is a module that controls the slave 50. The remote control module 300 may be attached to the slave 50 and may be physically separated from the slave 50. The program modules may be included in the remote control module 300 in the form of an operating system, an application program module, and other program modules.

The remote control module 300 may include a controller 310 and a communication unit 330.

The communication unit 330 may transmit and receive data to and from the control module 200 or the slave 50 over the network 199. The communication unit 330 may receive the synchronization release message, the resynchronization establishment message, and the information indicative of a motion of the master 10 from the control module 300.

The communication unit 330 may transmit and receive signals or data to and from the remote control module 300 or the slave 50 by using a LAN, wireless LANs (e.g., IEEE 802.11b, IEEE 802.11a, IEEE802.11g, and IEEE802.11n), wireless broadband (WIBro), Bluetooth, and ZigBee.

The controller 310 may release synchronization between the master 10 and the slave 50 when receiving the synchronization release message, and may reestablish synchronization between the master 10 and the slave 50 when receiving the resynchronization establishment message. Furthermore, when receiving the information indicative of a motion of the master 10 in the state 301 in which the master 10 and the slave 50 have been synchronized, the controller 310 may control the slave 50 to imitate the motion of the master 10 that is indicated by the information.

The controller 310 may execute a command, and may perform an operation associated with the slave 50. For example, the controller 310 may control a hardware component of the slave 50 based on an instruction retrieved from storage 320.

The controller 310, the storage 320, and the communication unit 330 are components corresponding to the controller 210, the storage 220, and the communication unit 320, respectively, and detailed descriptions thereof are omitted.

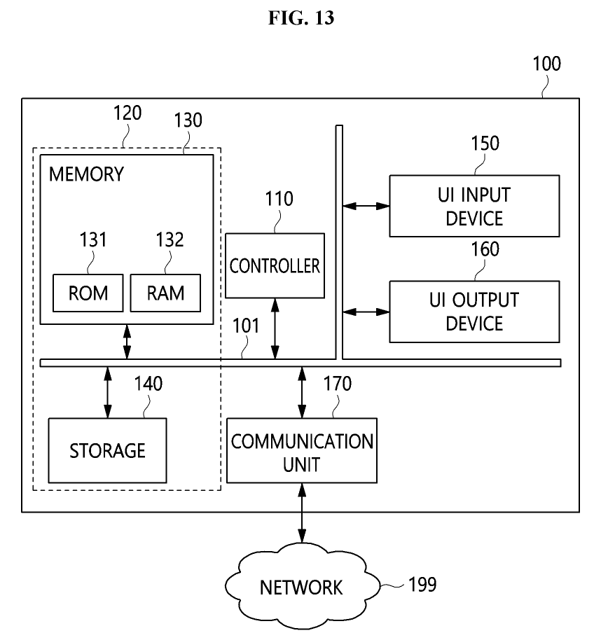

FIG. 13 is a view illustrating a configuration of a computer system according to an embodiment of the present disclosure.

Referring to FIG. 13, the control module 200, the remote control module 300, and the teleoperation processor 700 may be implemented in a computer system 100, such as a computer-readable recording medium.

The computer system 100 may include a bus 101, a controller 110, a storage 120, a user interface (UI) input device 150, a UI output device 160, and a communication unit 170. The storage 120 may include memory 130 and a storage 140. The controller 110, the memory 130, the storage 140, the UI input device 150, the UI output device 160, and the communication unit 170 may communicate with each other through the bus 101.

When the control module 200 is implemented with the computer system 100, the UI output device 160 may output the external audio signals 302 and 502.

When the remote control module 300 is implemented with the computer system 100, the UI output device 160 may display the avatar 50 on a screen or in the form of hologram.

The controller 110, storage 120, and communication unit 170 of the computer system 100 are components corresponding to the controller 210, the storage 220, and the communication unit 230 illustrated in FIG. 12, respectively, and detailed descriptions thereof are omitted hereinafter.

In the aforementioned embodiments, in applying specified processing to a specified target, a specified condition may be required. If it has been described that specified processing is performed under a specified determination, when it is described that whether the specified condition is satisfied is determined based on a specified coding parameter or that a specified determination is made based on a specified coding parameter, it may be interpreted that the specified coding parameter may be substituted with another coding parameter. In other words, the coding parameter that affects the specified condition or the specified determination may be considered as being merely exemplary. It may be understood that a combination of one or more other coding parameters in addition to the specified coding parameter may perform a role as the specified coding parameter.

In the aforementioned embodiments, although the methods have been described based on the flowcharts in the form of a series of steps or blocks, the present disclosure is not limited to the sequence of the steps, and some of the steps may be performed in the sequence different from that of other steps or may be performed simultaneously with other steps. Furthermore, those skilled in the art will understand that the steps shown in the flowchart are not exclusive and the steps may include additional steps or that one or more steps in the flowchart may be deleted without affecting the scope of rights of the present disclosure.

The aforementioned embodiments include various aspects of examples. Although all kinds of possible combinations for representing the various aspects may not be described, those skilled in the art will understand that other possible combinations are possible in addition to an explicitly described combination. Accordingly, the present disclosure should be construed as including all other replacements, modifications, and changes which fall within the scope of the claims.

The aforementioned embodiments according to the present disclosure may be implemented in the form of a program readable through various computer means, and may be written in a computer-readable recording medium. In this case, the computer-readable recording medium may include program instructions, a data file, and a data structure alone or in combination. The program instructions written in the computer-readable recording medium may be specially designed and constructed for the present disclosure, or may be known and available to those skilled in computer software.

The computer-readable recording medium may include information that is used in embodiments of the present disclosure. For example, the computer-readable recording medium may include a bit stream. The bit stream may include the information described in the embodiments of the present disclosure.

The bit stream may include a computer-executable code and/or program. The computer-executable code and/or program may include the pieces of information described in the embodiments, and may include the syntax elements described in the embodiments. In other words, the pieces of information and the syntax elements described in the embodiments may be considered as computer-executable codes within a bit stream, and may be considered as at least a part of a computer-executable code and/or program that is expressed as a bit stream.

The computer-readable recording medium may include a non-transitory computer-readable medium.

Examples of the computer-readable recording medium may include a hardware device specially configured to store and execute a program instruction, such as magnetic media such as a hard disk, a floppy disk, and a magnetic tape, optical media such as CD-ROM and a DVD, magneto-optical media such as a floptical disk, ROM, RAM, and flash memory. Examples of the program instructions may include not only a machine language wire constructed by a compiler, but a high-level language wire capable of being executed by a computer using an interpreter. Such a hardware device may be configured to act as one or more software modules in order to perform an operation of the present disclosure, and vice versa.

Although the present disclosure has been described in connection with specific matters, such as the detailed components, and the limited embodiments and drawings, they have been provided only to help general understanding of the present disclosure, and the present disclosure is not limited to the embodiments. Those skilled in the art to which the present disclosure pertains may modify the embodiments in various ways from the above description.

Accordingly, the spirit of the present disclosure should not be limited and determined by the aforementioned embodiments, and all things modified equally or equivalently with the claims in addition to the claims may be said to fall within the category of the spirit of the present disclosure.

What is claimed is:

1. A method of controlling a synchronization of a teleoperation based on a user-visual motion, the method comprising:
receiving a detection signal obtained by detecting a portion related to an eye of a master in a state in which the master and a slave have been synchronized;
identifying whether an eye closing motion of the master that closes the eye is held for a time indicated by a preset release threshold based on the received detection signal; and
releasing the synchronization when the eye closing motion is held for the time.

2. The method of claim 1, further comprising receiving a motion detection signal obtained by detecting a motion of the master,
wherein the identifying of whether the eye closing motion is held for the time comprises identifying whether the eye closing motion is held for the time in a state in which a stop of the motion of the master has been held, based on the received motion detection signal and the detection signal, and
the releasing of the synchronization comprises releasing the synchronization when the eye closing motion is held for the time in the state in which the stop of the motion of the master has been held.

3. The method of claim 1, wherein the releasing of the synchronization comprises providing an external audio signal to provide notification that a process of releasing the synchronization has been completed.

4. The method of claim 1, further comprising storing a slave pose of the slave at a time point at which the synchronization is released.

5. The method of claim 4, further comprising:
providing the stored slave pose in a state in which the synchronization has been released;
receiving a second motion detection signal obtained by detecting a motion of the master in the state in which the synchronization has been released;
identifying whether the master holds a pose associated with the slave pose for a second time indicated by a preset resynchronization threshold based on the received second motion detection signal in the state in which the synchronization has been released; and
performing resynchronization between the master and the slave when the associated pose is held for the second time.

6. The method of claim 5, further comprising receiving a second detection signal obtained by detecting a portion related to the eye of the master in the state in which the synchronization has been released,
wherein the identifying of whether the master holds the pose associated with the slave pose for the second time comprises identifying whether the eye closing motion is held for the second time based on the received second detection signal in the state in which the associated pose has been held, and
the performing of the resynchronization comprises performing the resynchronization when the eye closing motion is held for the second time in the state in which the associated pose has been held for the second time.

7. The method of claim 5, wherein the performing of the resynchronization comprises providing an external audio signal to provide notification that a process for the resynchronization has been completed.

8. The method of claim 1, wherein the eye of the master comprises a right eye and left eye of the master.

9. The method of claim 5, wherein the release threshold and the resynchronization threshold are identically or differently set.

10. A control module for controlling a synchronization of a teleoperation based on a user-visual motion, the control module comprising:
a storage configured to store a preset release threshold; and
a controller configured to receive a detection signal obtained by detecting a portion related to an eye of a master in a state in which the master and a slave have been synchronized, identify whether an eye closing motion of the master that closes the eye is held for a time indicated by a preset release threshold based on the received detection signal, and release the synchronization when the eye closing motion is held for the time.

11. The control module of claim 10, wherein the controller
receives a motion detection signal obtained by detecting a motion of the master,
identifies whether the eye closing motion is held for the time in a state in which a stop of the motion of the master has been held, based on the received motion detection signal and the detection signal, and
releases the synchronization when the eye closing motion is held for the time in the state in which the stop of the motion of the master has been held.

12. The control module of claim 10, wherein the controller controls so that an external audio signal indicating that a process of releasing the synchronization has been completed is provided.

13. The control module of claim 10, wherein the controller stores a slave pose of the slave at a time point at which the synchronization is released in the storage.

14. The control module of claim 13, wherein:
the storage further stores a preset resynchronization threshold, and
the controller
controls so that the stored slave pose is provided in a state in which the synchronization has been released,
receives a second motion detection signal obtained by detecting a motion of the master in the state in which the synchronization has been released;
identifies whether the master holds a pose associated with the slave pose for a second time indicated by a preset resynchronization threshold based on the received second motion detection signal in the state in which the synchronization has been released, and
performs resynchronization between the master and the slave when the associated pose is held for the second time.

15. The control module of claim 14, wherein the controller
receives a second detection signal obtained by detecting a portion related to the eye of the master in the state in which the synchronization has been released,
identifies whether the eye closing motion is held for the second time based on the received second detection signal in the state in which the associated pose has been held, and
performs the resynchronization when the eye closing motion is held for the second time in the state in which the associated pose has been held.

16. The control module of claim 14, wherein the controller controls so that an external audio signal indicating that a process for the resynchronization has been completed is provided.

17. The control module of claim 10, wherein the eye of the master comprises a right eye and left eye of the master.

18. The control module of claim 14, wherein the release threshold and the resynchronization threshold are identically or differently set.

19. A teleoperation system for controlling a synchronization of a teleoperation based on a user-visual motion, the teleoperation system comprising:
a sensor unit configured to output a detection signal obtained by detecting a portion related to an eye of a master; and
a control module configured to receive the detection signal in a state in which the master and a slave have been synchronized, identify whether an eye closing motion of the master that closes the eye is held for a time indicated by a preset release threshold based on the received detection signal, and release the synchronization when the eye closing motion is held for the time.

20. The teleoperation system of claim 19, wherein:
the sensor unit further outputs a motion detection signal obtained by detecting a motion of the master, and
the control module
receives the motion detection signal,
identifies whether the eye closing motion is held for the time in a state in which a stop of the motion of the master has been held, based on the received motion detection signal and the detection signal, and
releases the synchronization when the eye closing motion is held for the time in the state in which the stop of the motion of the master has been held.
